(19) United States
(12) Patent Application Publication
(10) Pub. No.: US 2018/0144311 A1
(43) Pub. Date: May 24, 2018

(54) SYSTEMS AND METHODS FOR MANAGING A JOINTLY FUNDED VIRTUAL PAYMENT REQUEST

(71) Applicant: MasterCard International Incorporated, Purchase, NY (US)

(72) Inventors: Rick Unnerstall, O'Fallon, MO (US); Linda M. Mautz, O'Fallon, MO (US); Erica Joann Robeen, Hardin, IL (US)

(21) Appl. No.: 15/355,526

(22) Filed: Nov. 18, 2016

(51) Int. Cl. G06Q 20/10; G06Q 40/02

(52) U.S. Cl. CPC G06Q 20/102; G06Q 20/108; G06Q 40/02

(57) ABSTRACT

A virtual payment account (VPA) management computing device is described, the VPA management computing device configured to generate a jointly funded payment request and store a user-selected control. The VPA management computing device is also configured to establish a VPA associated with the jointly funded payment request, the VPA configured to receive funds from a plurality of payors. The VPA management computing device is further configured to reformat the user-selected controls into corresponding withdrawal restriction rules associated with the VPA, and store the withdrawal restriction rules. The VPA management computing device is also configured to receive a withdrawal request to withdraw at least a portion of the funds in the VPA, the withdrawal request including a plurality of data elements, to compare the data elements with the withdrawal restriction rules, and, when the data elements satisfy the withdrawal restriction rules, to approve the withdrawal request.

### BACKGROUND

This disclosure relates to jointly funded virtual payment requests and, more specifically, to systems and methods for managing jointly funded virtual payment requests associated with virtual payment accounts (VPA).

Virtual and online fund-sharing platforms are becoming increasingly prevalent. Consumers appreciate the ease and flexibility of using an online platform to transfer funds to other parties, in contrast to writing checks or visiting a brick-and-mortar financial institution to initiate such a transfer. In particular, mobile platforms, which allow for the transfer of funds using a mobile device (e.g., a smart phone), offer increased convenience for consumers. Such fund-sharing platforms have made possible a wide variety of options for consumers to transfer and request funds, including requesting funds from a plurality of payors (i.e., a jointly funded request). In a jointly funded request, one consumer requests funds from a plurality of others, either in a fixed amount (e.g., $5 from every payor) or without a fixed amount (e.g., merely requesting participation from each payor). However, many consumers may be wary about how their funds are being used when they respond to such a jointly funded request. For example, a jointly funded request may be made to pay for a gift, but the requesting party may misuse the funds to make a personal purchase. In some cases, a jointly funded request may be directed to fulfilling a goal, such as receiving a certain amount of funds to purchase a particular item. However, if the final purchase price of the item is less than the goal, the primary consumer is left with the responsibility for refunding the other payors with the leftover funds. This can be time-consuming and difficult, and some primary consumers may forego this step altogether, which is another concern for payors.

Accordingly, there is a need for a system that reduces the likelihood of misuse of joint funds, as well as a system that enables refunding payors excess or remaining joint funds.

### BRIEF DESCRIPTION OF THE DISCLOSURE

In one aspect, a virtual payment account (VPA) management computing device including a processor in communication with a memory is provided. The processor is programmed to generate a jointly funded payment request in response to a command from a requestor, and store one or more user-selected controls associated with the jointly funded payment request in the memory. The processor is also programmed to establish a VPA associated with the jointly funded payment request, the VPA configured to receive funds from a plurality of payors. The processor is further programmed to reformat the user-selected controls into corresponding withdrawal restriction rules associated with the VPA, and store the withdrawal restriction rules within the memory in a memory location associated with the VPA. In addition, the processor is programmed to receive a withdrawal request to withdraw at least a portion of the funds in the VPA, the withdrawal request including a plurality of data elements, compare the plurality of data elements with the withdrawal restriction rules associated with the VPA, and, when the plurality of data elements satisfy the withdrawal restriction rules, approve the withdrawal request.

In another aspect, a method of managing a jointly funded payment request is provided. The method may be implemented using a virtual payment account (VPA) management computing device including a processor in communication with a memory. The method includes generating the jointly funded payment request in response to a command from a requestor, and storing one or more user-selected controls associated with the jointly funded payment request in the memory. The method also includes establishing a VPA associated with the jointly funded payment request, the VPA configured to receive funds from a plurality of payors. The method further includes reformatting the user-selected controls into corresponding withdrawal restriction rules associated with the VPA, and storing the withdrawal restriction rules in the memory within a memory location associated with the VPA. In addition, the method includes receiving a withdrawal request to withdraw at least a portion of the funds in the VPA, the withdrawal request including a plurality of data elements, comparing the plurality of data elements with the withdrawal restriction rules associated with the VPA, and when the plurality of data elements satisfy the withdrawal restriction rules, approving the withdrawal request.

In yet another aspect, a non-transitory computer-readable storage medium having computer-executable instructions embodied thereon is provided. When executed by a virtual payment account (VPA) management computing device including a processor in communication with a memory, the computer-executable instructions cause the VPA management computing device to generate a jointly funded payment request in response to a command from a requestor, and store one or more user-selected controls associated with the jointly funded payment request in the memory. The computer-executable instructions also cause the VPA management computing device to establish a VPA associated with the jointly funded payment request, the VPA configured to receive funds from a plurality of payors. The computer-executable instructions further cause the VPA management computing device to reformat the user-selected controls into corresponding withdrawal restriction rules associated with the VPA, and store the withdrawal restriction rules within the memory in a memory location associated with the VPA. In addition, the computer-executable instructions cause the VPA management computing device to receive a withdrawal request to withdraw at least a portion of the funds in the VPA, the withdrawal request including a plurality of data elements, compare the plurality of data elements with the withdrawal restriction rules associated with the VPA, and when the plurality of data elements satisfy the withdrawal restriction rules, approve the withdrawal request.

### BRIEF DESCRIPTION OF THE DRAWINGS

FIGS. 1-7 show example embodiments of the methods and systems described herein.

FIG. 1 is a block diagram of a virtual funding platform system including a virtual payment account (VPA) management computing device.

FIG. 2 illustrates an example configuration of a client computing device shown in FIG. 1.

FIG. 3 illustrates an example configuration of a server system shown in FIG. 1.

FIGS. 4A and 4B illustrate the flow of data between various components of the virtual funding platform system shown in FIG. 1.

FIG. 5 is a data flow diagram illustrating the flow of messages and funds between various components of the virtual funding platform system shown in FIG. 1.

FIG. 6 is a flowchart of a method for distributing remaining funds from a securely managed joint-funding request.

FIG. 7 is a diagram of components of an example computing device that may be used in the virtual funding platform system shown in FIG. 1.

Like numbers in the Figures indicates the same or functionally similar components. Although specific features of various embodiments may be shown in some figures and not in others, this is for convenience only. Any feature of any figure may be referenced and/or claimed in combination with any feature of any other figure.

### DETAILED DESCRIPTION OF THE DISCLOSURE

The systems and methods herein are configured to manage jointly funded payment requests, including adding controls to payment requests to prevent fraudulent use of the funds and automating reimbursement or redistribution of leftover funds.

The system described herein includes a virtual funding platform (VFP). The VFP system includes a virtual payment account (VPA) management computing device configured to perform at least some of the processes described herein. The VFP system (e.g., the VPA management computing device) is configured to maintain a funding request software application, referred to herein as a “funding app”. The funding app enables users to request funds from a plurality of other users to accomplish a group-funded or jointly funded goal, such as purchasing a gift for a person known to all users, contributing individual portions towards a group travel cost, funding an event, and/or any number of other jointly funded goals. Using the funding app, a requesting user (“requestor”) sets up a jointly funded payment request to be sent to a plurality of receiving/funding users (“payors”). The requestor inputs to the funding app a goal or target amount of funds and a short description of the jointly funded payment request (e.g., “$80 for this gift for Grandma”). The requestor can decide whether to impose an exact amount of funds for which each payor is responsible or to allow each payor to choose the amount of funds they wish to contribute.

The requestor can also select one or more controls to impose on the jointly funded payment request. Controls limit the use of the funds collected from a jointly funded payment request, to help ensure that the funds are used properly (i.e., for the use described by the requestor in the description of the jointly funded payment request). Controls available may include (but are not limited to) an expiration date/time, a payee merchant (i.e., the merchant at which a purchase transaction is initiated), an item identifier (e.g., SKU), a shipping address, a recipient name, and a geolocation (e.g., the location of the requestor when a withdrawal request, such as a purchase transaction, is made). In some embodiments, payors may request that one or more controls be added to the jointly funded payment request and/or one or more controls be updated or changed, after they have received the request. In the example embodiment, the VPA management computing device receives any user-selected controls and stores the user-selected controls (or an identifier thereof) in a memory location associated with the jointly funded payment request.

The requestor also identifies a plurality of payors to whom a notification of the jointly funded payment request is to be transmitted. The notification may be transmitted (e.g., by the VPA management computing device) via a variety of communication formats, including, but not limited to, email, Short Message Service (SMS) message, in-app notification and/or message within the funding app, and/or a social media message (e.g., a message received within a social media platform, such as a Facebook® message, a Twitter® Direct Message, a Snapchat® message, etc.). It should be understood that a payor may receive the notification via more than one format. Each payor may receive the notification on their user computing device, which may limit and/or direct the format of the notification. For example, where a user computing device includes a smartphone, the notification may be transmitted thereto and/or received thereby in any of the above-described formats, whereas a user computing device including a desktop computer may be unable to receive SMS messages and/or in-app notifications.

The requestor may identify the plurality of payors and/or the format in which the notification of the jointly funded payment request is to be transmitted based on the contact information available to the requestor. For example, the requestor may select the plurality of payors from a list of “contacts” within a social media platform, and the notification of the jointly funded payment request may be transmitted to the plurality of payors over the social media platform. Likewise, the requestor may select the plurality of payors from a “phonebook” (i.e., a list of phone numbers), and the notification may be transmitted to the plurality of payors via SMS message.

In the example embodiment, the VPA management computing device transmits the notification of the jointly funded payment request to a user computing device of each payor based on the communication format available thereto, as discussed above. Each payor may interact with the notification to access the jointly funded payment request, for example, by clicking a hyperlink embedded in the notification to the request. Each payor may then choose to “fund” the request, or to contribute an amount of funds to the request. If the request requires that each payor contribute a specific amount, when the payor funds the request, they automatically agree to contribute that specific amount. If the request allows a payor to choose the amount they wish to contribute, then the payor is presented with an option (e.g., a text entry field, set of buttons, drop-down menu, etc.) to select their preferred contribution amount.

To fund a jointly funded payment request, the payor must identify a payment account from which the chosen contribution amount of funds will be withdrawn. In some embodiments, each payor creates a profile associated with the virtual funding platform and provides payment account information to be stored in their profile. In such embodiments, the payment account information is stored with the consent of the payor, and is stored in an encrypted and/or otherwise secure format. For example, a format-preserving encryption scheme (such as from a prefix cipher, from cycle walking, or from a Feistel network, for example) may be implemented to encrypt a credit card number. In other embodiments, a payor may enter their payment account information each time they fund a jointly funded payment request, and the payment account information is not stored.

In the example embodiment, when a first payor elects to fund the request, the VPA management computing device generates a primary virtual payment account (VPA) associated with the jointly funded payment request. In one or more other embodiments, the VPA management computing device generates the primary VPA associated with the jointly funded payment request when the jointly funded payment request is initiated (e.g., prepared by the requestor and/or transmitted to the plurality of payors). Alternatively, the VPA may be generated and associated with a requestor and/or payor when the funding app is downloaded and installed onto a user computing device associated with the requestor and/or payor. As the app is installed, the VPA management computing device may send a VPA generation request to a VPA issuing system (e.g., a VPA issuing and maintenance system associated with the VFP platform system), which in turn may generate the VPA on behalf of an issuer bank. “Virtual payment account” (VPA), as used herein, refers generally to a “pseudo”-account and/or a pseudo-payment card, which exists only in a temporary and/or virtual format. The VPA has an associated number or identifier similar to a payment account number and/or payment card number, such that the VPA identifier can be used in many of the same circumstances in which a “real” payment account number and/or payment card number are used—for example, to make a purchase transaction. The VPA identifier may be a random or pseudo-random identifier, such as a random 16-digit number that functions as a payment card number. Alternatively, the VPA identifier may include certain non-random elements, such as a non-random 6-digit Bank Identification Number (BIN) preceding another (randomized) 10 digits. The BIN may function to identify the VPA management computing device and/or an issuing bank associated therewith, similar to a traditional BIN within a payment card number.

In one example embodiment, the VPA functions as a virtual prepaid account. When a payor elects to fund a jointly funded payment request, funds in the contribution amount are transferred from a payment account of the payor to the VPA. In some embodiments, the VPA is maintained at an issuing bank associated with the VPA management computing device, the requestor, and/or one or more of the payors. The issuing bank is responsible for withdrawing, holding, and transferring funds associated with the jointly funded payment request. In other embodiments, the VPA management computing device maintains the VPA, and is responsible for withdrawing, holding, and transferring funds associated with the jointly funded payment request without direct association with an issuing bank. Additionally or alternatively, the VPA is maintained at a specific VPA issuing system associated with the VFP platform system. The specific details of “transferring” from credit accounts and debit accounts are well known, and accordingly will not be discussed in further detail herein.

In alternative embodiments, when a payor elects to fund the request, the amount of funds the payor has chosen to contribute is “held” within their payment account. More particularly, the VPA management computing device transmits a “hold” instruction to a financial institution associated with the payment account, the hold instruction identifying the payment account and the amount of funds to be held. The funds will be held until a withdrawal request is made by the requestor to withdraw the funds associated with the jointly funded payment request, at which time the amount of funds (or a portion thereof) will be withdrawn from the payment account of the payor. In such embodiments, if a final withdrawal request (e.g., a final purchase price of a gift to be purchased) is less than a goal or target amount of the jointly funded payment request, the VPA management computing device will amend the hold instruction such that only a proportional amount of funds will be withdrawn from the payment account of the payor. For example, a target amount of the jointly funded payment request was sent at $80 to cover the purchase of an $80 gift, and each payor elected to contribute $20. The final purchase price, when the requestor purchases the gift, is $60. Accordingly, in some cases, only $15 of a “held $20” is actually withdrawn from a payor's payment account. In such embodiments, fewer payment processing network messages (e.g., transfer instructions) may be generated and processed. In other cases, the full $20 is withdrawn and $5 are refunded according to the refund processes described herein.

The VPA management computing device is further configured to associate stored user-selected controls—previously associated with the jointly funded payment request—with the generated VPA. In addition, the VPA management computing device is configured to format the user-selected controls into a format that permits automatic comparison with data fields in a purchase transaction authorization request message (e.g., an ISO 8583 network message) and/or in any other withdrawal request message. The user-selected controls may be selected by the requestor (and/or a payor) in a natural-language format. For example, a merchant-specific control may be selected by the requestor entering “Gap” into a text entry box, or an item-specific control may be selected by entering an item description (“Jersey”) and/or a hyperlink to the item. The VPA management computing device is configured to reformat these natural-language controls into withdrawal restriction rules (e.g., network-message data elements). For example, the VPA management computing device may perform a merchant lookup to determine a merchant identifier that corresponds to “Gap”, and may store that merchant identifier as a merchant-specific withdrawal restriction rule. Similarly, the VPA management computing device may perform analysis on a linked page and/or perform an item lookup to determine an item identifier (e.g., a price or SKU) that corresponds to the natural-language item description or hyperlink. The VPA management computing device may store the item identifier as an item-specific withdrawal restriction rule. The VPA management computing device is configured to reformat each user-selected control associated with the jointly funded payment request into a corresponding withdrawal restriction rule. The VPA management computing device associates withdrawal restriction rules with the VPA identifier and stores the withdrawal restriction rules in a memory location associated with the VPA.

In addition, the VPA management computing device transmits the credentials (e.g., VPA identifier) of the VPA to the requestor. In some embodiments, the VPA management computing device automatically transmits the VPA credentials to the requestor upon generation of the VPA, such that the requestor may use the credentials of the VPA to initiate a withdrawal request at any time. For example, the VPA credentials including a VPA account number (similar to a prepaid card number) may be accessible to the requestor through the funding app. Alternatively, the VPA management computing device may transmit the credentials of the VPA to the requestor in response to certain conditions being met, such as the expiration date of the jointly funded payment request occurring, the jointly funded payment request being fully funded, upon request from the requestor, etc.

A “withdrawal request,” as used herein, may include a purchase transaction and/or a “pure” withdrawal request (e.g., a request to access “in cash” the funds associated with the jointly funded payment request, in cases where no purchase transaction will be made, or a transfer request to transfer the funds to a payment account of the requestor). The requestor initiates a withdrawal request to use the funds contributed by the payors for the goal described in the jointly funded payment request. Because the requestor must use the VPA credentials to initiate the withdrawal request, a notification of the withdrawal request (“approval request”) is automatically transmitted to the VPA management computing device for approval of the withdrawal request. The approval request is transmitted to the VPA management computing device by the computing device (e.g., a point-of-sale device, a merchant server, a bank server, etc.) receiving and processing the initiated withdrawal request—also referred to as a “withdrawal computing device”. The approval request includes a plurality of data elements associated with the initiated withdrawal request, including a time/date stamp, an identifier of the withdrawal computing device (e.g., a merchant identifier, in the case of a purchase transaction), a nature of the withdrawal request (e.g., purchase transaction, cash withdrawal, etc.), and/or any other data elements. During purchase transactions in particular, data elements associated with the purchase are included in the approval request, such as a SKU of an item being purchased, a shipping address associated with the purchase, a name of the purchaser, etc. The approval request may be formatted in an encrypted format such that any personally identifiable information (PII) is protected, and/or may be formatted as a network message transmitted over a payment processing network (e.g., an ISO 8583 network message, such as an authorization request message).

The VPA management computing device receives the approval request associated with the VPA and queries a memory location associated with the VPA to determine whether there are any associated withdrawal restriction rules. The VPA management computing device accesses the stored withdrawal restriction rules and compares data elements in the approval notification to the withdrawal restriction rules associated with the VPA. For example, the VPA management computing device compares a merchant identifier in the approval request with a merchant-specific withdrawal restriction rule. As another example, the VPA management computing device compares a shipping address in the approval request with a shipping address-specific withdrawal restriction rule. If any of the data elements do not satisfy one or more withdrawal restriction rules, the VPA management computing device denies the withdrawal request such that the withdrawal request is declined. If all of the associated withdrawal restriction rules are satisfied, the VPA management computing device approves the withdrawal request for further processing.

In addition, the VPA management computing device compares the amount of the withdrawal request (i.e., an amount of funds requested to be withdrawn from the VPA associated with the jointly funded payment request) with the amount of funds available in the VPA. When the withdrawal request fully depletes the funds available in the VPA, the VPA management computing device invalidates or deactivates the VPA credentials such that the VPA is no longer available for use. If the withdrawal request does not fully deplete the funds available in the VPA, the VPA management computing device initiates a refund distribution process to distribute any remaining balance in the VPA. The VPA management computing device may then invalidate or deactivate the VPA credentials such that the VPA is no longer available for use. The VPA management computing device may maintain the VPA in an inactive or deactivated state for a predetermined period of time, such as a clearing or settlement period, in the event a chargeback is issued for a purchase transaction.

The VPA management computing device first determines how to distribute the remaining balance. In the example embodiment, the VPA management computing device distributes a respective portion of the remaining balance to each payor in an amount associated with that payor's contribution amount. In one case, the portion of the remaining balance distributed to each payor is proportional to that payor's contribution amount. Taking one example in which $80 was funded for a gift that cost $60 when purchased, one payor contributed $40 (50% of the total contributed funds), one payor contributed $25 (31.25% of the total contributed funds), and one payor contributed $15 (18.75% of the total contributed funds). Of the $20 remaining in the VPA after the purchase, the VPA management computing device distributes $10 to the first payor (50% of the remaining balance), $6.25 to the second payor (31.25% of the remaining balance), and $3.75 to the third payor (18.75% of the remaining balance). In another case, the portion of the remaining balance distributed to each payor is an equal portion of the remaining balance. For the same example, each payor would receive $6.66 of the remaining $20 (and/or one payor may receive $6.67).

Although the VPA management computing device has been described as initiating the refund distribution process in response to a withdrawal request that does not fully deplete the funds in a VPA, the VPA management computing device is configured to initiate the refund distribution process in response to any trigger event. Trigger events include the initiation and/or completion of a withdrawal request that does not fully deplete the funds in a VPA, as described above; the expiration of a timer control associated with a jointly funded payment request (in which case all funds contributed to the VPA are refunded to the payors in the contribution amounts); receipt of a specific “refund distribution request” from the requestor (e.g., in cases in which multiple withdrawal requests are permitted from the same VPA); and/or alternative trigger events. The VPA management computing device initiates the refund distribution process in response to detection of the trigger event.

Once the portion of the remaining balanced owed to each payor is determined, the VPA management computing device transfers respective funds in the determined amounts to each payor. In one embodiment, the VPA management computing device transfers funds in the determined amount from the VPA to the payment account associated with a payor, from which the initial fund contribution was made. In another embodiment, the VPA management computing device generates a “secondary VPA” for each payor. The VPA management computing device transfers the respective funds for each payor into a corresponding VPA. The VPA management computing device then transmits access credentials to that secondary VPA to the respective payor, such that the payor may access the funds therein with a withdrawal request. In some embodiment, the VPA management computing device is further configured to determine if any loyalty rewards or the like were distributed to any payor and/or requestor based on the initial contribution amount. If so, the VPA management computing device determines whether any loyalty rewards need to be “refunded” or otherwise removed from an associated loyalty program profile. In such cases, the VPA management computing device is configured to transmit a message similar to a chargeback or refund message to a server associated with the relevant loyalty program, such that typical refund processing of loyalty program rewards may be initiated.

In some embodiments, the VPA management computing device is configured to transmit one or more update notifications to the payors associated with a jointly funded payment request after the withdrawal request has been approved (e.g., a purchase is completed). For example, the VPA management computing device may transmit an update notification notifying each payor that a withdrawal request has been approved. Additionally or alternatively, the VPA management computing device may transmit an update notification notifying each payor whether any full or partial refund will be distributed, and, if so, the amount of the refund to each payor.

Described herein is one example implementation of the VFP system managing a jointly funded payment request and refund distribution. In this example, a requestor generates a jointly funded payment request. More particularly, the requestor requests $80 from a plurality of payors to purchase a selected gift. The requestor selects one or more controls to place on the jointly funded payment request, such as an item identifier (of the selected gift), a shipping address (e.g., a shipping address of the giftee), and/or any other control, as described herein. The VPA management computing device reformats any user-selected controls into corresponding withdrawal restriction rules, as described herein. The VPA management computing device transmits the jointly funded payment request to the plurality of payors. In this instance, the jointly funded payment request is fully funded. In other words, the payors together fund the request with $80. A first payor funds the request with $40, a second payor funds the request with $25, and a third payor funds the request with $15. One of the payors may be the same person as the requestor. As each payor funds the request with their selected amount of funds, those funds are transferred from a respective payment account associated with each payor into a VPA generated by the VPA management computing device.

The requestor prepares to initiate the purchase transaction for the selected gift using the credentials of the VPA (e.g., a VPA identifier that functions as a pseudo-payment card number). At the time she initiates the purchase transaction, the selected gift is on sale for $60. The requestor makes the purchase transaction. The VPA management computing device compares data elements in a transaction approval request associated with the purchase transaction—for example, a shipping address, billing address, item identifier of the selected gift—with the withdrawal restriction rules associated with the jointly funded payment request (and the VPA). If the data elements satisfy the withdrawal restriction rules, the VPA management computing device approves the withdrawal of funds from the VPA, functioning much like an “issuer” of the VPA.

In this instance, there are $20 remaining in the VPA. The VPA management computing device is configured to initiate a reimbursement process upon approval of the purchase transaction. In a first embodiment, the $20 is distributed evenly between the payors. The VPA management computing device withdraws the remaining balance of $20 and distributes an equal portion of the $20 (e.g., $6.66, $6.66, and $6.67) to a financial account associated with each payor. Alternatively, the VPA management computing device may generate a “secondary” VPA, separate from the (primary) VPA associated with the joint-funded payment request, for each payor. The VPA management computing device may then distribute the funds into each secondary VPA and may provide access credentials to one such secondary VPA to each payor. In this manner, the VPA management computing device need not access and/or store any credentials for the (real) payment accounts associated with the payors. In a second embodiment, the $20 is distributed proportionally to each payor in accordance with the amount of funds each payor contributed to the jointly funded payment request. The first payor contributed 50% of the funds, the second payor contributed 31.25% of the funds, and the third payor contributed 18.75% of the funds. The VPA management computing device divides the remaining balance into portions according to those proportions ($10, $6.25, and $3.75, respectively) and distributes those portions to the payors as described above.

In the example implementation, any information stored on the VFP system does not include any personally identifiable information (PII), but rather includes processed, anonymized, and/or aggregated data that does not specifically identify a user (e.g., a requestor or a payor). In other implementations, where the VFP system may store PII, any stored PII is encrypted and/or otherwise secured. Moreover, in any implementations in which PII may be collected, the user from which the PII may be collected is provided an opportunity to agree to or deny collection of such data.

The methods and systems described herein may be implemented using computer programming or engineering techniques including computer software, firmware, hardware, or any combination or subset therefor. At least one of the technical problems addressed by this system includes: (i) the need for manual redistribution of leftover funds in a jointly funded payment account; (ii) ease of fraudulent use of funds from a jointly funded payment request, especially in situations in which funds are collected via person-to-person (P2P) payments; (iii) excessive payment processing network messages transmitted for individual P2P payments in jointly funded payment requests; and (iv) lack of centralized controls or restrictions rules over jointly funded payment requests.

The technical effect of the systems and methods described herein is achieved by performing at least one of the following steps: (a) generating the jointly funded payment request in response to a command from a requestor; (b) storing one or more user-selected controls associated with the jointly funded payment request in the memory; (c) establishing a VPA associated with the jointly funded payment request, the VPA configured to receive funds from a plurality of payors; (d) reformatting the user-selected controls into corresponding withdrawal restriction rules associated with the VPA; (e) storing the withdrawal restriction rules within the memory in a memory location associated with the VPA; (f) receiving a withdrawal request to withdraw at least a portion of the funds in the VPA, the withdrawal request including a plurality of data elements; (g) comparing the plurality of data elements with the withdrawal restriction rules associated with the VPA; and/or (h) when the plurality of data elements satisfy the withdrawal restriction rules, approving the withdrawal request.

The resulting technical effect achieved by the systems and methods described herein is at least one of: (i) automatic redistribution of leftover funds; (ii) reduced fraud in the use of joint funds using added controls; (iii) improved ease of access and use of joint funds using a virtual payment account to manage funds; (iv) centralized control over jointly funded payment requests; (v) centralized restriction over withdrawal requests; (vi) consolidated network messaging and fund transfer management; (vii) reduced network messages and network traffic; and (viii) potential merchant savings in implementations in which processing of a VPA carries reduced fees over typical credit card processing.

In one embodiment, a computer program is provided, and the program is embodied on a computer-readable medium. In an example embodiment, the IOA system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the IOA system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing purchase patterns in industrial, commercial, and residential applications.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

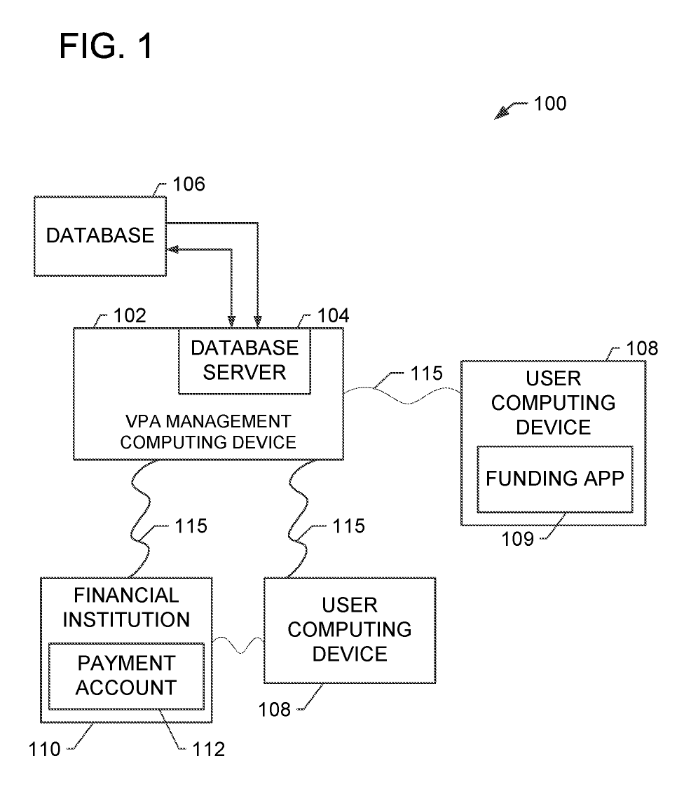

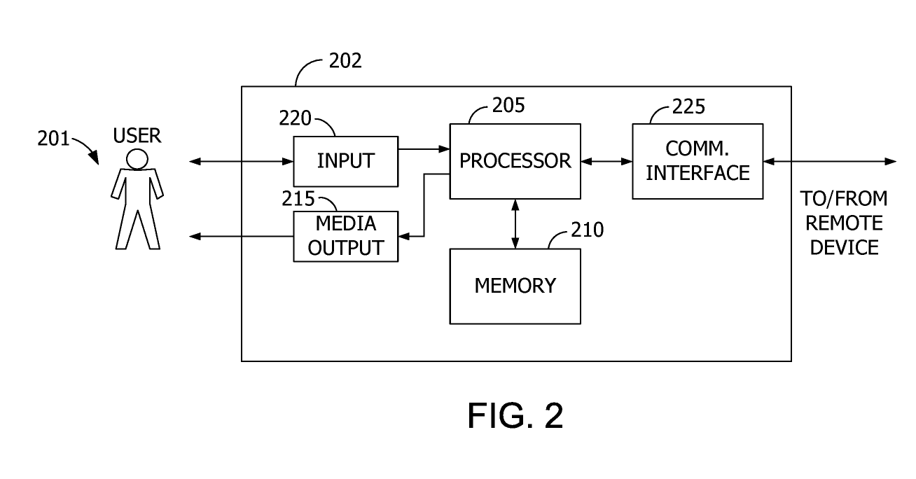

FIG. 1 is a block diagram of a virtual funding platform (VFP) system 100 including a virtual payment account (VPA) management computing device 102. VPA management computing device 102 includes at least one processor in communication with a memory. Additionally, a database server 104 is in communication with a database (memory) 106 containing information on a variety of matters, including active funding requests, associated user-selected controls, corresponding withdrawal restriction rules, registered payment account information, and/or any other information used in managing jointly funded payment requests as described herein. In one embodiment, database 106 is stored on VPA management computing device 102. In any alternative embodiment, database 106 is stored remotely from VPA management computing device 102 and may be non-centralized.

In the example embodiment, VFP system 100 further includes a plurality of client subsystems, also referred to as client systems or user computing devices 108. In one embodiment, user computing devices 108 are computers including a web browser, such that VPA management computing device 102 is accessible to user computing devices 108 using the Internet. User computing devices 108 are interconnected to the Internet through many interfaces including a network 115, such as a local area network (LAN) and/or a wide area network (WAN), dial-in connections, cable modems, wireless-connections, and special high-speed ISDN lines. User computing devices 108 may be any device capable of interconnecting to the Internet including a mobile computing device, such as a laptop or desktop computer, a web-based phone (e.g., a “smartphone”), a personal digital assistant (PDA), a tablet or phablet, a fitness wearable device, a smart refrigerator or other web-connectable appliance, a “smart watch” or other wearable device, or other web-connectable equipment. Although two user computing devices 108 are shown in FIG. 1 for clarity, it should be understood that VFP system 100 may include any number of user computing devices 108.

User computing devices 108 are further configured to run a funding app 109, which is downloaded and/or installed on user computing device 108. Funding app 109 enables access to the jointly funded request management capabilities of VPA management computing device 102 via user computing devices 108. Although a software application (“app”) is described herein, it should be understood that the same or substantially similar functionality may be achieved through a browser-based website (e.g., a website hosted by VPA management computing device 102).

VFP system 100 further includes at least one financial institution 110 (e.g., a bank). Financial institution 110 maintains one or more financial or payments accounts 112 associated with users or consumers (e.g., payors and/or payees). VPA management computing device 102 is configured to communicate with financial institution 110 to transmit instructions thereto directing financial institution 110 to, for example, place holds on one or more financial accounts 112 and/or transfer money to/from one or more financial accounts 112.

In one embodiment, VPA management computing device 102 is configured to communicate with a user computing device 108 associated with a user (not shown). User computing device 108 is configured to display funding app 109, for example, at a user interface (described further herein). Funding app 109 may be stored in a cloud-based storage platform (not shown), which may include cloud storage capability as well as any cloud-based API that facilitates communication between a user computing device 108 and VPA management computing device 102 and/or between user computing device 108 and a financial institution 110. The user accesses funding app 109 to initiate, view, update, and/or manage jointly funded payment requests. At least one user computing device 108 is associated with a jointly funded payment request requestor, and at least one user computing device 108 is associated with jointly funded payment “request receiver”, also referred to herein as a “payor”.

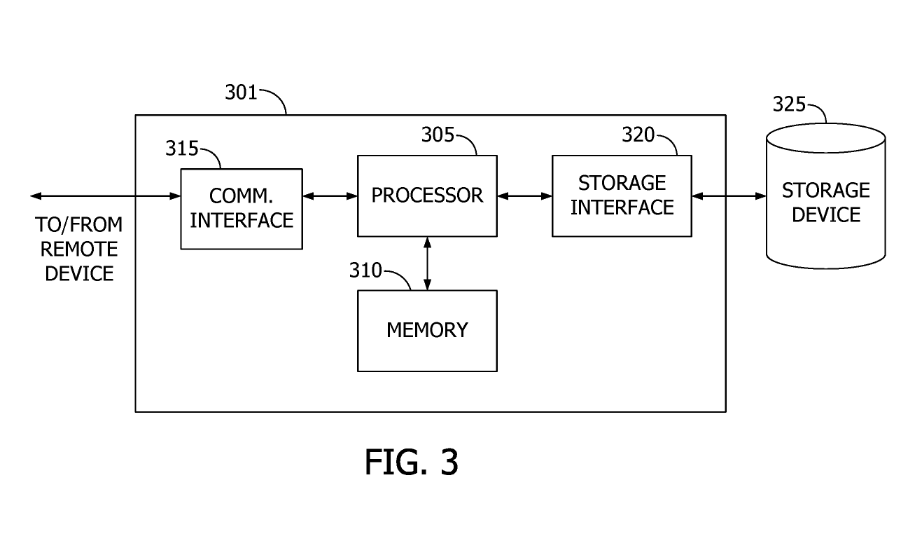

FIG. 2 illustrates an example configuration of a client computing device 202. Client computing device 202 may include, but is not limited to, user computing devices 108 shown in FIG. 1. Client computing device 202 includes a processor 205 for executing instructions. In some embodiments, executable instructions are stored in a memory 220. Processor 205 may include one or more processing units (e.g., in a multi-core configuration). Memory 220 is any device allowing information such as executable instructions and/or other data to be stored and retrieved. Memory 220 may include one or more computer-readable media.

Client computing device 202 also includes at least one media output component 215 for presenting information to a user 201. Media output component 215 is any component capable of conveying information to user 201. In some embodiments, media output component 215 includes an output adapter such as a video adapter and/or an audio adapter. An output adapter is operatively coupled to processor 205 and operatively coupleable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 202 includes an input device 220 for receiving input from user 201. Input device 220 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 215 and input device 220.

Client computing device 202 may also include a communication interface 225, which is communicatively coupleable to a remote device such as VPA management computing device 102 (shown in FIG. 1) or a web server operated by a merchant. Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory 220 are, for example, computer-readable instructions for providing a user interface to user 201 via media output component 215 and, optionally, receiving and processing input from input device 220. A user interface may include, among other possibilities, a web browser and client application. Web browsers enable users 201 to display and interact with media and other information typically embedded on a web page or a website from a web server associated with a merchant. A client application allows users 201 to interact with a server application associated with, for example, a VFP system 100 (shown in FIG. 1), such as funding app 109 (also shown in FIG. 1).

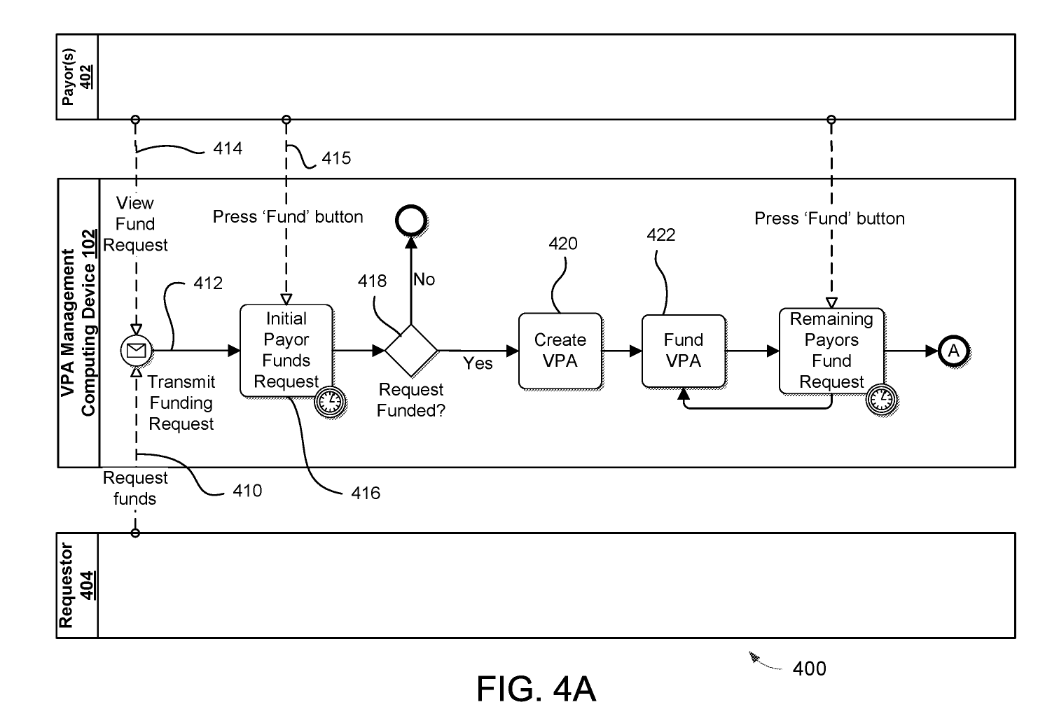

FIG. 3 illustrates an example configuration of a server computing device 301. Server computing device 301 may include, but is not limited to, VPA management computing device 102 and/or financial institution 110 (both shown in FIG. 1), such as a bank server. Server computing device 301 includes a processor 305 for executing instructions. Instructions may be stored in a memory 310, for example. Processor 305 may include one or more processing units (e.g., in a multi-core configuration).

Processor 305 is operatively coupled to a communication interface 315 such that server computing device 301 is capable of communicating with a remote device such as client computing device 202 or another server computing device 301. For example, communication interface 315 may receive requests from user computing devices 108 via the Internet, as illustrated in FIG. 1.

Processor 305 may also be operatively coupled to a storage device 325. Storage device 325 is any computer-operated hardware suitable for storing and/or retrieving data. In some embodiments, storage device 325 is integrated in server computing device 301. For example, server computing device 301 may include one or more hard disk drives as storage device 325. In other embodiments, storage device 325 is external to server computing device 301 and may be accessed by a plurality of server computing devices 301. For example, storage device 325 may include multiple storage units such as hard disks or solid state disks in a redundant array of inexpensive disks (RAID) configuration. Storage device 325 may include a storage area network (SAN) and/or a network attached storage (NAS) system.

In some embodiments, processor 305 is operatively coupled to storage device 325 via a storage interface 320. Storage interface 320 is any component capable of providing processor 305 with access to storage device 325. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 325.

Memory 310 and Memory 220 (shown in FIG. 2) may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

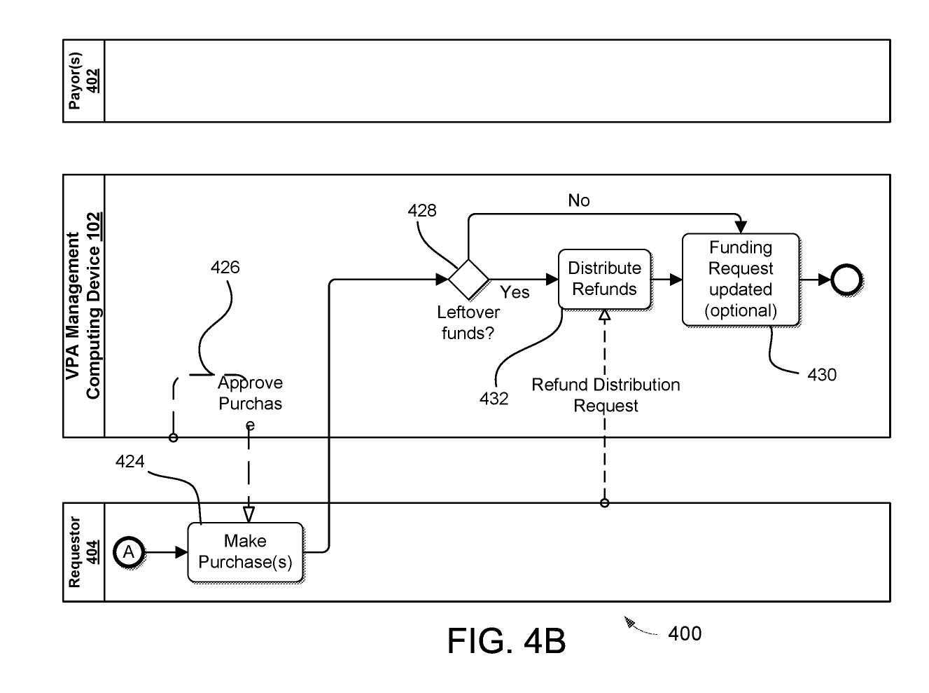

FIGS. 4A and 4B are a data flow diagram 400 illustrating the flow of various messages and data between components of VFP system 100 (shown in FIG. 1). More specifically, information exchange between payors 402 (e.g., a payor user computing device 108, as shown in FIG. 1), a payee or requestor 404 (e.g., a payee user computing device 108), and VPA management computing device 102 is illustrated. It should be understood that although only one payor 402 is illustrated, any number of payors 402 may participate in a joint-funding process.

Requestor 404 requests 410 funds by initiating a jointly funded payment request. Requestor 404 may request 410 funds from any number of payors 402 by identifying each payor 402 in the initiated request (e.g., by name, contact information, social media profile information, etc.). In addition, requestor 404 may set any selected controls on the jointly funded payment request when they request 410 funds to initiate the jointly funded payment request. VPA management computing device 102 transmits 412 the jointly funded payment request and/or a notification thereof to each of the identified payors 402 (e.g., to one or more user computing devices 108 associated with each payor 402). Each payor 402 may then view 414 the received jointly funded payment request (or notification). In one embodiment, payor 402 views 414 the jointly funded payment request using funding app 109 (shown in FIG. 1) installed on their user computing device 108. Additionally or alternatively, payor 402 views 414 the jointly funded payment request in any other format (e.g., in an email, a text/SMS message, etc.). In some embodiments, the jointly funded payment request includes pictures, a description, a story, a call-out of the target payors 402, and/or any other information that may be viewed 414 by payor 402. Payors 402 may view 414 the requestor-selected controls, in some embodiments, imposed on the jointly funded payment request, to assure payors 402 of the reduced risk of fraudulent use of any funds.

One first or initial payor 402 funds 416 the jointly funded payment request with funds in a contribution amount. In one embodiment, the first payor 402 funds 416 the jointly funded payment request by selecting 415 a “fund” command (e.g., a selectable button) within funding app 109. Each payor 402 funds 416 the jointly funded payment request by a fixed, requested contribution amount or by a selected contribution amount, according to the specific controls set for the jointly funded payment request. VPA management computing device 102 is configured to wait and maintain the jointly funded payment request until VPA management computing device 102 determined 418 that the initial payor 402 funded 416 the jointly funded payment request.

When VPA management computing device 102 determines 418 that the jointly funded payment request has been funded, VPA management computing device 102 generates or creates 420 a VPA associated with the jointly funded payment request, as described herein. Based on the contribution amount of funds contributed by the initial payor 402, VPA management computing device 102 funds 422 the created VPA (e.g., by withdrawing funds in the contribution amount from a payment account 112 associated with the initial payor 402).

One or more additional payors 402 fund 422 the jointly funded payment request with selected contribution amounts, and VPA management computing device 102 funds 422 the created VPA with funds in the contribution amounts. VPA management computing device 102 maintains the jointly funded payment request and the created VPA until a trigger event occurs. As described herein, the trigger event may include expiration of the jointly funded payment request or a withdrawal request. In the illustrated embodiment, the trigger event includes a withdrawal request, specifically a purchase request initiated by requestor 404 using account credentials of the created VPA.

Requestor 404 makes a purchase 424 in accordance with the user-selected controls imposed on the jointly funded payment request. VPA management computing device 102 approves 426 the purchase. In one example embodiment, VPA management computing device 102 compares transaction data associated with the purchase with specifically formatted withdrawal restriction rules corresponding to the user-selected controls in determining whether to approve or deny the purchase.

VPA management computing device 102 determines 428 whether there are any remaining funds in the VPA associated with the jointly funded payment request. If not, VPA management computing device 102 may update 430 the jointly funded payment request. Updating 430 the jointly funded payment request may include cancelling or deleting the jointly funded payment request, transmitting an update message to any identified payors 402 (e.g., notifying the payors 402 that the request has been funded), and/or maintaining the jointly funded payment request for a predetermined period of time but disabling any further funding of the jointly funded payment request.

If there are remaining funds in the VPA associated with the jointly funded payment request, VPA management computing device 102 is configured to distribute 432 a refund of funds to any payor 402 that funded the jointly funded payment request, as described herein. In some embodiments, requestor 404 may request 434 distribution of any remaining funds in the VPA to cause VPA management computing device 102 to distribute refunds. After distributing 432 the refunds, VPA management computing device 102 may update 430 the jointly funded payment request.

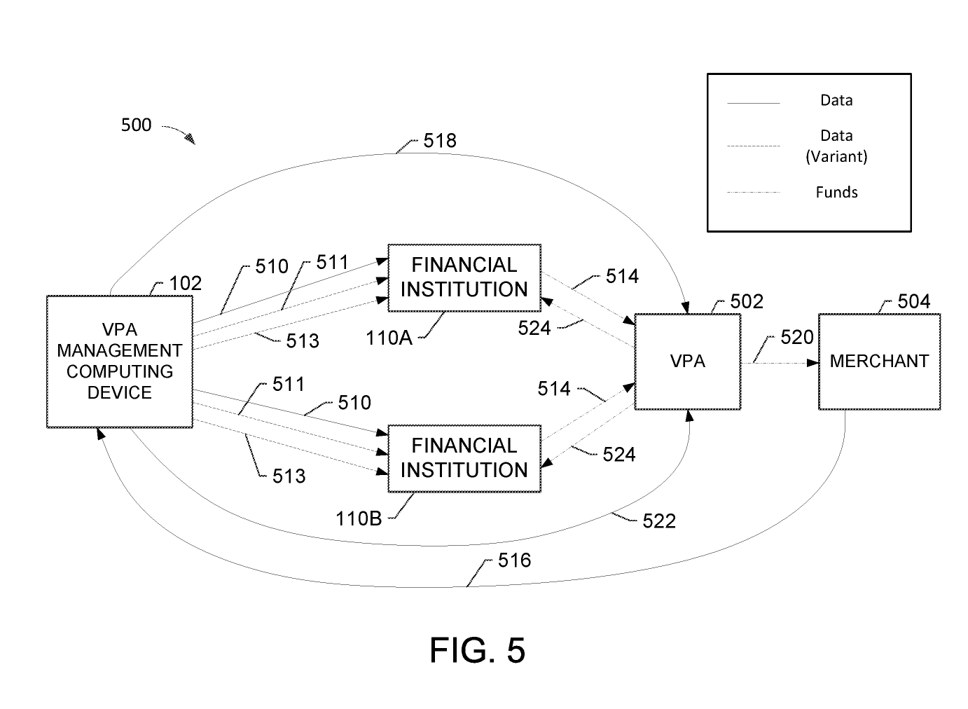

FIG. 5 is a data flow diagram 500 illustrating the flow of messages and funds between various components of virtual funding platform system 100 (shown in FIG. 1). Specifically, data flow diagram 500 illustrates the flow of messages and funds between VPA management computing device 102, financial institutions 110A and 110B, a VPA 502 generated by VPA management computing device 102, and a merchant 504. Financial institutions 110A and 110B represent the financial institutions of two payors that have elected to fund a jointly funded payment request. Merchant 504 may include a merchant, a merchant server, and/or a merchant bank (acquirer).

In data flow diagram 500, solid lines represent the transmittal of data, including instructions (e.g., hold or transfer instructions) and requests (e.g., authorization requests). Any or all of these data messages may be formatted as a network-format message specific to a payment processing network, such as an ISO 8583 message. Additionally or alternatively, any of all of these data messages may be otherwise formatted. For example, one or more data messages may be formatted as an in-app message on funding app 109 (shown in FIG. 1), an email, a text/SMS message, etc. In the illustrated embodiment, “variant” data messages (e.g., alternatives or optional steps) are shown using a dashed line. Dot-dash lines represent the transmittal of funds between parties.

Initially, once a payor has elected to fund a jointly funded payment request with a contribution amount, VPA management computing device 102 transmits an instruction 510 to financial institution 110A/110B associated with that payor. Instruction 510 causes that financial institution 110A/110B to initiate a transmittal of funds 514 in the contribution amount to VPA 502. These steps may be repeated any number of times, for as many payors as choose to fund the jointly funded payment request.

In the illustrated embodiment, a trigger event includes a purchase transaction occurs. Specifically, merchant 504 transmits an approval request 516 (e.g., an authorization request message) to VPA management computing device 102. Approval request 516 includes a plurality of data elements, including a transaction amount. If VPA management computing device 102 approves the approval request 516, VPA management computing device 102 transmits an instruction 518 to VPA 502. Instruction 518 causes VPA to initiate a release or transmittal of funds 520 to merchant 504 in the transaction amount.

If there are leftover or remaining funds in VPA 502 after the purchase transaction is complete, VPA management computing device 102 transmits an instruction 522 to VPA 502. Instruction 522 causes VPA 502 to initiate a refund or transmittal of funds 524 back to financial institutions 110A/110B in refund amounts. As described herein, the refund amounts correspond to a percentage of the transaction amount that was contributed by each payor, an equal amount of the remaining funds, and/or any other suitable division of the remaining funds.

In some embodiments, instead of transmitting instruction 510, VPA management computing device 102 transmits variant instruction 511, which includes a hold instruction. Variant instruction 511 causes financial institution 110A/110B to put a “hold” on funds in a payment account 112 (shown in FIG. 1), associated with the respective payor, in the contribution amount specified by the payor. In these embodiments, transmittal of funds 514 does not occur prior to the purchase transaction. Rather, the approval request 516 is transmitted as described above. When VPA management computing device 102 approves the approval request, VPA management computing device 102 also transmits an updated variant instruction 513 to financial institutions 110A/110B. Updated variant instruction 513 causes financial institutions 110A/110B to initiate transmittal of funds 514 to VPA 502 in a final amount based on the transaction amount of the purchase transaction. For example, if the transaction amount was less than an anticipated “goal amount” for the jointly funded payment request, updated variant instruction 513 may cause transmittal of funds 514 in amounts less than the contribution amounts selected by payors. In these embodiments, no refund transmittal of funds 524 is necessary, as only the appropriate amount(s) of funds were ever transmitted from payment accounts 112 at financial institutions 110A/110B.

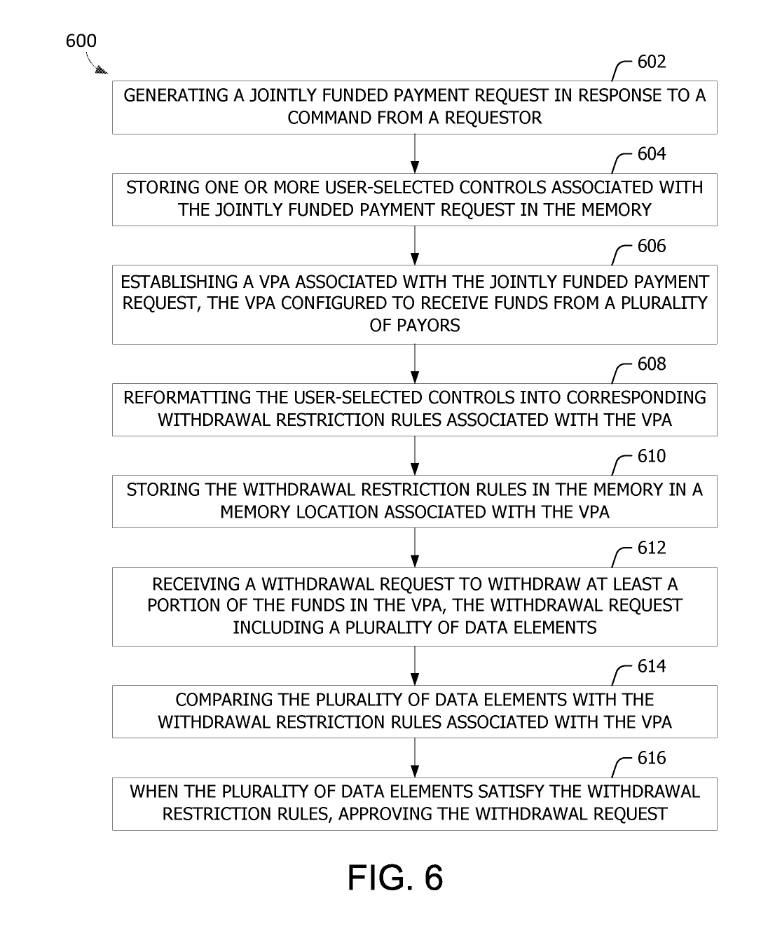

FIG. 6 is a flowchart of a method 600 for managing jointly funded payment requests. Method 600 may be implemented using VPA management computing device 102 (shown in FIG. 1). Method 600 may include additional, alternative, and/or fewer steps than shown in FIG. 6. At least some of the steps illustrated in FIG. 6 may be similar to steps of the data flow diagram 400 illustrated in FIGS. 4A and 4B and/or may be similar to steps of the data flow diagram 500 illustrated in FIG. 5.

In the illustrated embodiment, method 600 includes generating 602 a jointly funded payment request in response to a command from a requestor, and storing 604 one or more user-selected controls associated with the jointly funded payment request in the memory. The user-selected controls may be selected by the requestor and/or by one or more payors, as described herein.

Method 600 also includes establishing 606 a VPA associated with the jointly funded payment request. The VPA is configured to receive funds from a plurality of payors. Method 600 includes reformatting 608 the user-selected controls into corresponding withdrawal restriction rules associated with the VPA, and storing 610 the withdrawal restriction rules within the memory in a memory location associated with the VPA (and/or associating the withdrawal restriction rules with a VPA identifier of the VPA).

Method 600 further includes receiving 612 a withdrawal request to withdraw at least a portion of the funds in the VPA, the withdrawal request including a plurality of data elements. Method 600 includes comparing 614 the plurality of data elements with the withdrawal restriction rules associated with the VPA, and, when the plurality of data elements satisfy the withdrawal restriction rules, approving 616 the withdrawal request.

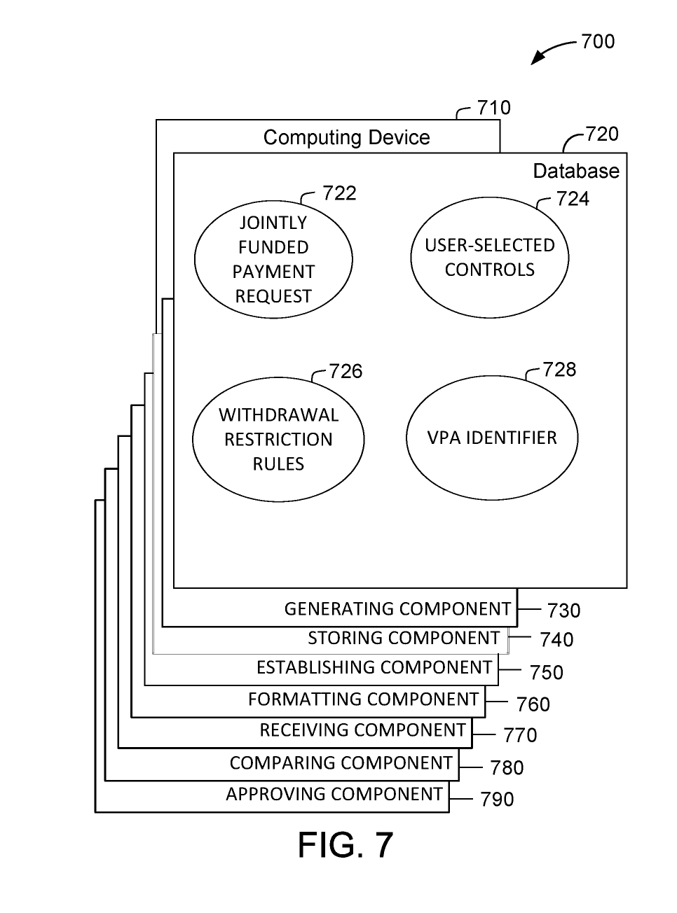

FIG. 7 is a diagram 700 of components of an example computing device 710 that may be used in the VFP system 100 shown in FIG. 1. In some embodiments, computing device 710 is similar to VPA computing device 102 (shown in FIG. 1). Computing device 710 includes a database 720 configured to store various information. Database 720 may be similar to database 104 (shown in FIG. 1). In the illustrated embodiment, database 720 stores one or more jointly funded payment requests 722, user-selected controls 724 associated with a jointly funded payment request 722, withdrawal restriction rules 726 corresponding to the user-selected controls 724, and VPA identifiers 728 associated with each VPA generated (in association with each jointly funded payment request 722).

Database 720 is in communication with a plurality of components of computing device 710 configured to execute specific tasks. In particular, computing device 710 includes a generating component 730. Generating component 730 is configured to generate a jointly funded payment request 722 in response to a user command from a requestor. Computing device 710 also includes a storing component 740 (which may be integral to database 720) configured to store user-selected controls 724 associated with the jointly funded payment request 722 in a memory (e.g., in database 720). Storing component 740 is further configured to store withdrawal restriction rules 726 within the memory in a memory location associated with a VPA.

Computing device 710 further includes an establishing component 750 configured to establish a VPA associated with the jointly funded payment request 722, the VPA configured to receive funds from a plurality of payors. In some embodiments, establishing component 750 may be in communication with, similar to, and/or integral to generating component 730.

In the illustrated embodiment, computing device 710 also includes a formatting component 760. Formatting component 760 is configured to reformat the user-selected controls 724 into corresponding withdrawal restriction rules 726 associated with the VPA. Computing device 710 further includes a receiving component 770 configured to receive a withdrawal request to withdraw at least a portion of the funds in the VPA. The withdrawal request includes a plurality of data elements. Receiving component 770 may be integral to any kind of communication device, such as a transceiver.

Computing device 610 still further includes a comparing component 780, wherein comparing component 780 is configured to compare the plurality of data elements with the withdrawal restriction rules 726 associated with the VPA, and an approving component 790, wherein approving component 790 is configured to approve the withdrawal request when the plurality of data elements satisfy the withdrawal restriction rules 726.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 205, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

In addition, although various elements of the VPA computing device are described herein as including general processing and memory devices, it should be understood that the VPA computing device is a specialized computer configured to perform the steps described herein for managing jointly funded payment requests and accounts.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A virtual payment account (VPA) management computing device comprising a processor in communication with a memory, said processor programmed to:
generate a jointly funded payment request in response to a command from a requestor;
store one or more user-selected controls associated with the jointly funded payment request in the memory;
establish a VPA associated with the jointly funded payment request, the VPA configured to receive funds from a plurality of payors;
reformat the user-selected controls into corresponding withdrawal restriction rules associated with the VPA;
store the withdrawal restriction rules within the memory in a memory location associated with the VPA;
receive a withdrawal request to withdraw at least a portion of the funds in the VPA, the withdrawal request including a plurality of data elements;
compare the plurality of data elements with the withdrawal restriction rules associated with the VPA; and
when the plurality of data elements satisfy the withdrawal restriction rules, approve the withdrawal request.

2. The VPA management computing device of claim 1, wherein said processor is further programmed to reformat the user-selected controls into withdrawal restriction rules including ISO 8583 network message-compatible data elements.

3. The VPA management computing device of claim 1, wherein said processor is further programmed to:
determine a remaining balance of funds in the VPA after the withdrawal is approved; and
initiate a refund distribution process to distribute the remaining balance of funds between the plurality of payors.

4. The VPA management computing device of claim 3, wherein said processor is further configured to distribute the remaining balance of funds by transferring equal portions of the remaining balance of funds to each of the plurality of payors.

5. The VPA management computing device of claim 3, wherein said processor is further configured to distribute the remaining balance of funds by transferring portions of the remaining balance of funds to each of the plurality of payors in amounts corresponding to a contribution amount contributed to the VPA by each of the plurality of payors.

6. The VPA management computing device of claim 1, wherein said processor is further configured to:
receive an election to contribute a first portion of the funds in the VPA from a first payor of the plurality of payors; and
place a hold on a payment account associated with the first payor in an amount corresponding to the first portion of the funds until detection of the withdrawal request.

7. The VPA management computing device of claim 1, wherein said processor is further configured to:
receive an election to contribute a first portion of the funds in the VPA from a first payor of the plurality of payors; and
transmit an instruction to a financial institution associated with the first payor to transmit funds in an amount corresponding to the first portion of the funds from a payment account associated with the first payor to the VPA.

8. The VPA management computing device of claim 1, wherein the one or more user-selected controls include at least one of an expiration date, an item identifier, a payee identifier, and a shipping address.

9. A method of managing a jointly funded payment request, the method implemented using a virtual payment account (VPA) management computing device including a processor in communication with a memory, the method comprising:
generating the jointly funded payment request in response to a command from a requestor;
storing one or more user-selected controls associated with the jointly funded payment request in the memory;
establishing a VPA associated with the jointly funded payment request, the VPA configured to receive funds from a plurality of payors;
reformatting the user-selected controls into corresponding withdrawal restriction rules associated with the VPA;
storing the withdrawal restriction rules within the memory in a memory location associated with the VPA;
receiving a withdrawal request to withdraw at least a portion of the funds in the VPA, the withdrawal request including a plurality of data elements;
comparing the plurality of data elements with the withdrawal restriction rules associated with the VPA; and
when the plurality of data elements satisfy the withdrawal restriction rules, approving the withdrawal request.

10. The method of claim 9, wherein reformatting the user-selected controls comprises reformatting the user-selected controls into withdrawal restriction rules including ISO 8583 network message-compatible data elements.

11. The method of claim 9 further comprising:
determining a remaining balance of funds in the VPA after the withdrawal is approved; and
initiating a refund distribution process to distribute the remaining balance of funds between the plurality of payors.

12. The method of claim 11 further comprising distributing the remaining balance of funds by transferring equal portions of the remaining balance of funds to each of the plurality of payors.

13. The method of claim 11 further comprising distributing the remaining balance of funds by transferring portions of the remaining balance of funds to each of the plurality of payors in amounts corresponding to a contribution amount contributed to the VPA by each of the plurality of payors.

14. The method of claim 9 further comprising:
receiving an election to contribute a first portion of the funds in the VPA from a first payor of the plurality of payors; and
placing a hold on a payment account associated with the first payor in an amount corresponding to the first portion of the funds until detection of the withdrawal request.

15. The method of claim 9 further comprising:
receiving an election to contribute a first portion of the funds in the VPA from a first payor of the plurality of payors; and
transmitting an instruction to a financial institution associated with the first payor to transmit funds in an amount corresponding to the first portion of the funds from a payment account associated with the first payor to the VPA.

16. A non-transitory computer-readable storage medium having computer-executable instructions embodied thereon, wherein when executed by a virtual payment account (VPA) management computing device including a processor in communication with a memory, the computer-executable instructions cause the VPA management computing device to:
generate a jointly funded payment request in response to a command from a requestor;
store one or more user-selected controls associated with the jointly funded payment request in the memory;
establish a VPA associated with the jointly funded payment request, the VPA configured to receive funds from a plurality of payors;
reformat the user-selected controls into corresponding withdrawal restriction rules associated with the VPA;
store the withdrawal restriction rules within the memory in a memory location associated with the VPA;
receive a withdrawal request to withdraw at least a portion of the funds in the VPA, the withdrawal request including a plurality of data elements;
compare the plurality of data elements with the withdrawal restriction rules associated with the VPA; and
when the plurality of data elements satisfy the withdrawal restriction rules, approve the withdrawal request.

17. The non-transitory computer-readable storage medium of claim 16, wherein the computer-executable instructions further cause the VPA management computing device to reformat the user-selected controls into withdrawal restriction rules including ISO 8583 network message-compatible data elements.

18. The non-transitory computer-readable storage medium of claim 16, wherein the computer-executable instructions further cause the VPA management computing device to:
determine a remaining balance of funds in the VPA after the withdrawal is approved; and
initiate a refund distribution process to distribute the remaining balance of funds between the plurality of payors.

19. The non-transitory computer-readable storage medium of claim 18, wherein the computer-executable instructions further cause the VPA management computing device to distribute the remaining balance of funds by transferring portions of the remaining balance of funds to each of the plurality of payors in amounts corresponding to a contribution amount contributed to the VPA by each of the plurality of payors.

20. The non-transitory computer-readable storage medium of claim 15, wherein one or more the user-selected controls include at least one of an expiration date, an item identifier, a payee identifier, and a shipping address.
